(19) United States
(12) Patent Application Publication
(10) Pub. No.: US 2025/0121413 A1
(43) Pub. Date: Apr. 17, 2025

(54) MOISTENER COLUMN FOR AN AGRICULTURAL HEADER

(71) Applicant: CNH Industrial America LLC, New Holland, PA (US)

(72) Inventors: Eric Underwood, McCune, KS (US); Daniel Krieg, Anamosa, IA (US); Jordan Beckhusen, McGregor, TX (US); Michael Joseph Horejsi, Sherrard, IL (US); Timothy Alan Meeks, Donahue, IA (US)

(21) Appl. No.: 18/911,888

(22) Filed: Oct. 10, 2024

Related U.S. Application Data
(60) Provisional application No. 63/589,775, filed on Oct. 12, 2023.

(51) Int. Cl. B08B 1/40; A01D 46/16; B08B 1/20; B08B 3/04; B33Y 80/00

(52) U.S. Cl. CPC B08B 1/40; A01D 46/16; B08B 1/20; B08B 3/04; B33Y 80/00

(57) ABSTRACT

A method for manufacturing a moistener column assembly for a row unit of an agricultural header includes forming a moistener column of the moistener column assembly via an additive manufacturing process. The moistener column includes an inlet region configured to receive fluid while installed on the row unit. The moistener column includes a body formed via the additive manufacturing process that extends from the inlet region. The inlet region is disposed on a first end of the body and includes a fluid passages formed via the additive manufacturing process that extend through the body to fluid outlets formed via the additive manufacturing process. Each of the fluid passages is configured to receive the fluid from the inlet region and to expel the fluid through a respective fluid outlet of the fluid outlets.

### CROSS-REFERENCE TO RELATED APPLICATION

This application claims priority from and the benefit of U.S. Provisional Application Ser. No. 63/589,776, entitled “MOISTENER COLUMN FOR AN AGRICULTURAL HEADER”, filed Oct. 12, 2023, which is hereby incorporated by reference in its entirety.

### BACKGROUND OF THE INVENTION

The present disclosure relates generally to a moistener column for an agricultural header.

Agricultural harvesters are used to harvest agricultural products (e.g., seed cotton or other natural material(s)). For example, an agricultural harvester may include a header having row units configured to harvest the agricultural product from a field. Each row unit may include components for stripping the agricultural product (e.g., seed cotton) from the plants and removing other agricultural material (e.g., residue) from the agricultural product. For example, each row unit may include spindles that rotate as the agricultural harvester moves through the field to remove seed cotton from the plants. After removing the seed cotton from the plants, doffers may remove the seed cotton from the spindles, and the seed cotton may be transported to an accumulator via an air-assisted conveying system.

### BRIEF DESCRIPTION

In certain embodiments, a method for manufacturing a moistener column assembly for a row unit of an agricultural header includes forming a moistener column of the moistener column assembly via an additive manufacturing process. The moistener column includes an inlet region formed via the additive manufacturing process. The inlet region is configured to receive fluid while installed on the row unit. The moistener column includes a body formed via the additive manufacturing process that extends from the inlet region. The inlet region is disposed on a first end of the body and includes fluid passages formed via the additive manufacturing process that extend through the body. The fluid passages extend to the inlet region to fluid outlets formed via the additive manufacturing process. Each of the fluid passages is configured to receive the fluid from the inlet region and to expel the fluid through a respective fluid outlet. The fluid outlets are distributed along a longitudinal axis of the moistener column assembly.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having a header;

FIG. 2 is a side schematic view of a row unit that may be employed within the header of FIG. 1;

FIG. 3 is a top schematic view of the row unit of FIG. 2;

FIG. 4 is a perspective view of an embodiment of a moistener column assembly that may be employed within the row unit of FIG. 2;

FIG. 5 is an exploded view of a portion of the moistener column assembly of FIG. 4;

FIG. 6 is a cross-sectional view of a moistener column of the moistener column assembly of FIG. 4;

FIG. 7 is a cross-sectional view of a portion of the moistener column of FIG. 6;

FIG. 8 is a cross-sectional view of a portion of the moistener column assembly of FIG. 4;

FIG. 9 is a perspective view of a moistener pad assembly of the moistener column assembly of FIG. 4;

FIG. 10 is a cross-sectional view of an embodiment of a moistener column that may be employed within the moistener column assembly of FIG. 4; and

FIG. 11 is a perspective view of another embodiment of a moistener column that may be employed within the moistener column assembly of FIG. 4.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

A harvester engages crops and separates portions of the crops into agricultural product (e.g., seed cotton) and other agricultural materials (e.g., chaff, residue) as the harvester travels across an agricultural field. The harvester includes a header having one or more row units, and each row unit is configured to separate the agricultural product from the plants using a spindle assembly. In addition, doffers remove the agricultural product (e.g., seed cotton) from the spindles of the spindle assembly, and the agricultural product may be transported to an accumulator via an air-assisted conveying system. To reduce build-up of plant gum/resin on the spindles, a moistener column assembly may output a cleaning solution (e.g., fluid) to clean the spindles as the harvester travels across the agricultural field. For example, the moistener column assembly may include moistener pad assemblies that apply the cleaning solution to the spindles. During operation of the harvester, other agricultural materials (e.g., chaff, residue) and debris may accumulate on components of the moistener column assembly, such as on cleaning fluid hoses that extend from an inlet to the moistener pad assemblies. As a result, the moistener assembly components may be cleaned frequently. Frequent cleaning may reduce the operational time of the harvester, thereby reducing harvesting efficiency. Furthermore, in certain row units, the moistener column assembly includes multiple components and weldments that are assembled to form the complete moistener column assembly. For example, multiple cleaning fluid hoses may be connected to an inlet and to multiple moistener pad assemblies, thereby utilizing significant assembly time.

The moistener column assembly disclosed herein significantly reduces the number of components, thereby substantially reducing assembly time and the number of components that may accumulate other agricultural materials and debris during operation of the agricultural harvester. As discussed in detail below, the moistener column assembly is formed using additive manufacturing (e.g., 3D printing) and includes a moistener column. The moistener column includes an inlet region and a body that extends from the inlet region on a first end of the body. Further, fluid passages formed by material of the body extend through the body to the inlet region of the moistener column to fluid outlets. The inlet region installed on the row unit receives fluid and the fluid is received by the fluid passages extending through the body and expel the fluid through a respective fluid outlet distributed along a longitudinal axis of the body. Because the moistener column of the moistener column assembly is formed by an additive manufacturing process, the fluid passages extending from the inlet region to the fluid outlets pass through the body, thereby obviating cleaning fluid hoses. As a result, the number of components that may accumulate other agricultural materials and debris is substantially reduced, thereby reducing the duration associated with cleaning the moistener column assembly. In addition, the process of assembling and disassembling the moistener column assembly may be substantially reduced because the process of routing and coupling the hoses is obviated. In addition, because the moistener column assembly does not include cleaning fluid hoses, the possibility of a hose becoming disconnected or pinched is substantially reduced or eliminated.

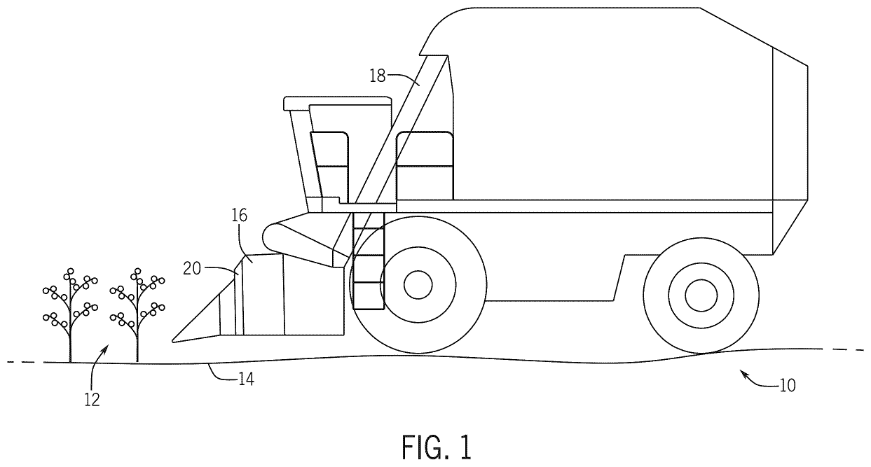

Turning now to the drawings, FIG. 1 is a side view of an embodiment of an agricultural system 10 (e.g., harvester, agricultural harvester) having a header. The agricultural system 10 is configured to harvest agricultural product 12 (e.g., seed cotton) from an agricultural field 14. In the illustrated embodiment, the agricultural system 10 includes a header 16 having row units 20 configured to harvest the agricultural product 12 from the agricultural field 14. Additionally, the agricultural system 10 includes an air-assisted conveying system 18 configured to move the agricultural product 12 from the row units 20 of the header 16 to an accumulator of the agricultural system 10. The row units 20 (e.g., four row units, six row units, ten row units) of the header 16 are configured to harvest the agricultural product 12 from the agricultural field 14. As discussed in detail below, each row unit 20 includes spindles, a doffer, and a moistener column assembly to facilitate separation of the agricultural product 12 from other agricultural materials and debris.

The row units 20 of the header 16 are positioned and angled to cause the spindles to engage the agricultural product 12 near the base of the plants to facilitate harvesting. Each row unit 20 includes a spindle assembly having spindles that rotate to remove the agricultural product 12 (e.g., seed cotton) from the plants in the agricultural field 14. As the spindle assembly rotates, the spindles move the agricultural product 12 to a doffer. The doffer includes doffer lugs that remove the agricultural product from the spindles. The spindle assembly rotates as the agricultural system 10 moves through the agricultural field 14. As such, the spindles remove other agricultural material and debris during collection and doffing of the agricultural product 12. Each row unit includes a moistener column assembly to clean the spindles, thereby removing build-up of plant gum/resin from the spindles.

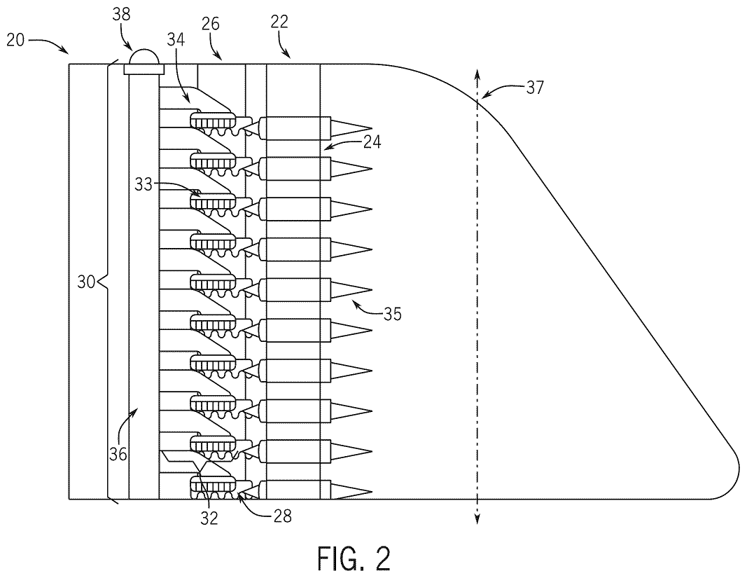

FIG. 2 is a side schematic view of a row unit 20 that may be employed within the header of FIG. 1. In the illustrated embodiment, the row unit 20 includes a spindle assembly 22 that includes multiple spindles 24 used to pull the agricultural product from the plants. The row unit 20 also includes a doffer 26, which includes multiple doffer lugs 28 used to strip the agricultural product from the spindles as the spindle assembly rotates. The row unit 20 also includes a moistener column assembly 30 including moistener pad assemblies 32 to clean the spindles during harvesting operations. Each moistener pad assembly 32 includes a moistener pad 33 and a moistener pad holder 34. The moistener pad holder 34 couples the moistener pad 33 to a moistener column 36 of the moistener column assembly 30. The moistener column assembly 30 also includes a cap 38 configured to direct cleaning fluid into the moistener column during operation.

The moistener column assembly 30 is configured to clean the spindles 24 as the spindle assembly 22 rotates. In certain embodiments, the spindles 24 rotate and contact the moistener pads 33 coupled to the moistener column 36 of the moistener column assembly 30. The moistener pads 33 remove build-up of plant gum/resin from the spindles 24 to enable the spindles 24 to remain in condition to harvest the agricultural product 12. In certain embodiments, each moistener pad 33 includes openings that enable the cleaning solution to flow from the moistener pads 33 of the moistener column 36 to the spindles 24 of the spindle assembly 22 when in contact.

In the illustrated embodiment, the spindles 24 are distributed generally vertically and include protrusions 35 that are positioned around the spindle assembly 22 in an alternating pattern. The generally vertical distribution of the protrusions 35 enables the agricultural product (e.g., seed cotton) to be stripped from the plants at various heights. As used herein, “generally vertical” refers to an orientation that is within a threshold angle of a vertical axis, such as within 1 degree of the vertical axis, within 3 degrees of the vertical axis, within 5 degrees of the vertical axis, within 10 degrees of the vertical axis, or within 15 degrees of the vertical axis.

Further, in the illustrated embodiment, the moistener pad assemblies 32 are distributed along a longitudinal axis 37 of the moistener column assembly 30 in an evenly spaced configuration. The evenly spaced configuration of the moistener pad assemblies 32 enables the spindles 24 to be cleaned as the spindle assembly 22 rotates. While the moistener pad assemblies 32 are evenly spaced in the illustrated embodiment, in other embodiments, the moistener pad assemblies may be arranged in any other suitable pattern. Furthermore, in certain embodiments, the number of moistener pad assemblies 32 of the moistener column assembly 30 may be equal to the number of spindles 24 in the spindle assembly 22. In some embodiments, the number of spindles 24 in the spindle assembly 22 may be greater than the number of moistener pad assemblies 32. The number of spindles 24 and the number of moistener pad assemblies 32 in FIG. 2 is a non-limiting example, and the moistener column assembly 30 may include more or fewer moistener pad assemblies 32, the spindle assembly 22 may include more or fewer spindles 24, or a combination thereof.

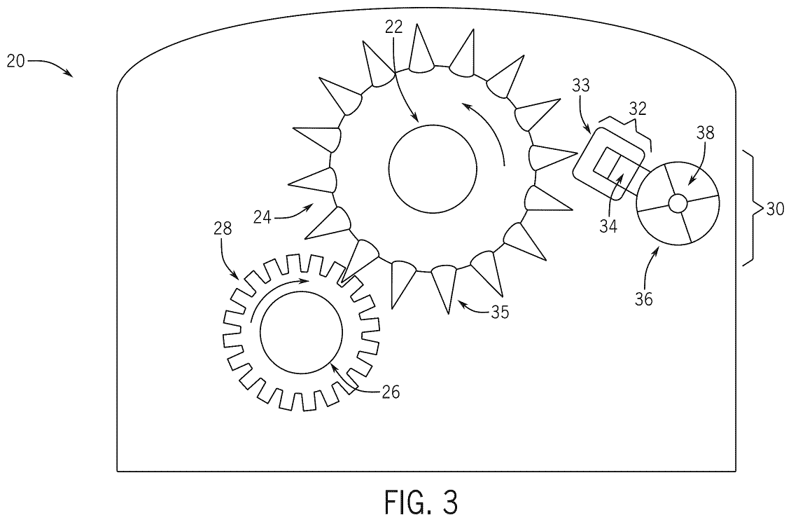

FIG. 3 is a top schematic view of the row unit 20 of FIG. 2. As discussed above, the row unit 20 includes the spindle assembly 22 that includes the spindles 24 configured to rotate during harvesting operations. The spindle assembly interacts with the doffer 26 so that the doffer lugs 28 strip the agricultural product from the spindles as the agricultural system moves through the agricultural field. The spindle assembly 22 also interacts with the moistener column assembly 30. In some embodiments, the protrusions 35 of the spindles 24 just touch the moistener pads 33 to clean the spindles of plant gum and/or resin, as well as other build-up. For example, when the agricultural system is harvesting the agricultural product in an agricultural field with significant amounts of cockleburs, the moistener column assembly 30 may remove such undesired material from the spindles 24. In certain embodiments, agricultural product removed by the doffer lugs 28 of the doffer 26 may accumulate on the moistener column assembly 30. As such, the moistener column assembly 30 may require the routine removal of build-up after certain periods of time (e.g., time, loads, passes in the agricultural field). Due to the structure of the moistener column 36, the moistener column assembly 30 can easily be cleaned (e.g., pressure washed, blown with compressed air) without detachment of external components.

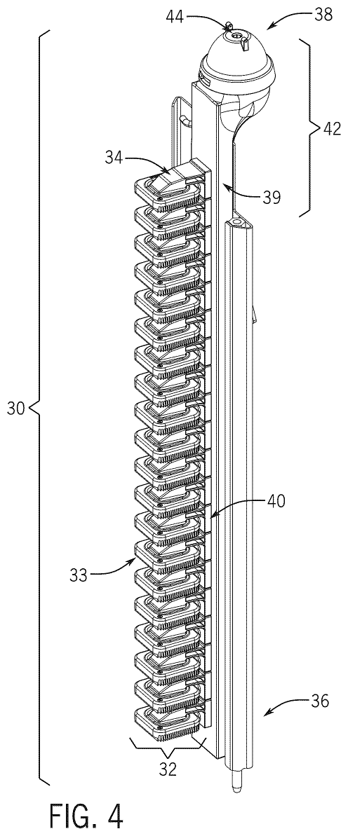

FIG. 4 is a perspective view of an embodiment of the moistener column assembly 30 that may be employed within the row unit of FIG. 2. The moistener column assembly 30 is arranged generally vertically and includes the moistener pad assemblies 32. As previously discussed, each moistener pad assembly 32 includes a moistener pad 33, which is secured to a respective moistener pad holder 34. In addition, each moistener pad holder 34 is coupled to a body 39 of the moistener column 36. Cleaning solution may flow from respective fluid outlets 40 to surfaces of the moistener pads 33. An inlet assembly 42 of the moistener column assembly 30 includes the cap 38 having a fluid inlet 44. The fluid inlet 44 is configured to receive cleaning solution from a solution tank.

Further, in the illustrated embodiment, the moistener column assembly 30 includes twenty moistener pads 33. In certain embodiments, the number of moistener pads 33 of the moistener column assembly 30 may be equal to the number of spindles in the spindle assembly. As such, the protrusions of the spindles may be cleaned by the moistener pads 33. In the illustrated embodiment, each moistener pad holder 34 is connected to the body 39 with a respective bolt (e.g., fastener). In other embodiments, at least one moistener pad holder may be connected to the body with multiple bolts, screw(s), rivet(s), other suitable fastener(s), or a combination thereof. Furthermore, in certain embodiments, each moistener pad holder 34 is formed using additive manufacturing (e.g., 3D printing, etc.). In some embodiments, the moistener pad assemblies 32 may be individually replaced without replacement of the moistener column assembly 30.

In the illustrated embodiment, the moistener column 36 of the moistener column assembly 30 is formed as one piece, as compared to moistener column configurations that include a number of parts. Accordingly, the illustrated moistener column significantly reduces the duration associated with assembly of the moistener column assembly. For example, in the illustrated embodiment, the moistener column is formed via additive manufacturing (e.g., 3D printing) in a single step. For example, the single step occurs through printing the moistener column using one or more printing technologies (e.g., fused deposition modeling, stereolithography, selective laser sintering, material jetting, metal 3D printing, etc.). In certain embodiments, the moistener column may be formed through combination of a few parts (e.g., two, three, four), in which each part is made through additive manufacturing. In other embodiments, the moistener column of the moistener column assembly is formed by casting and/or machining one or more parts. For example, in certain embodiments, the moistener column may be formed from two parts, in which the first part is formed by additive manufacturing, and the second part is formed by casting/machining.

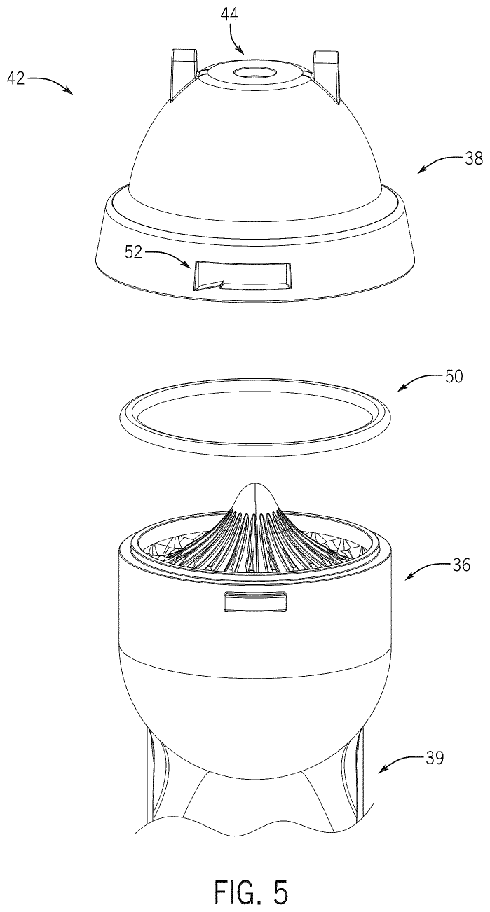

FIG. 5 is an exploded view of a portion of the moistener column assembly 30 of FIG. 4. As previously discussed, the inlet assembly 42 of the moistener column assembly 30 includes the cap 38 having the fluid inlet 44. The fluid inlet 44 is configured to receive cleaning solution from the solution tank. An o-ring 50 is added to seal the body 39 of the moistener column 36 and the cap 38. Further, to provide ease of access to the body 39, the cap 38 includes a quarter-turn snap connector 52 that engages a corresponding connector on the body 39 to couple the cap 38 to the body 39 in response to rotation of the cap 38. Engaging the quarter-turn snap connector 52 with the corresponding connector compresses the o-ring 50, thereby establishing a seal between the cap 38 and the body 39, which enables the cleaning solution to flow into the body 39. In certain embodiments, the cap 38, including the quarter-turn snap connector 52, and the body 39, including the corresponding connector, are formed through additive manufacturing.

The quarter-turn snap connector configuration facilitates coupling the cap to the body without the use of fasteners (e.g., bolts, screws), thereby simplifying the coupling process. In addition, the flow of cleaning solution through the inlet assembly may be enhanced (e.g., as compared to an inlet assembly that includes fasteners which may interfere with the flow of the cleaning solution from the fluid inlet to the body). While the cap is coupled to the body with the quarter-turn snap connector configuration in the illustrated embodiment, in other embodiments, the cap may be coupled to the body by a threaded connection, by a magnetic connection, by a fastener connection, by other suitable type(s) of connection(s), or a combination thereof. Furthermore, while the moistener column assembly includes an o-ring in the illustrated embodiment, in other embodiments, the o-ring may be omitted.

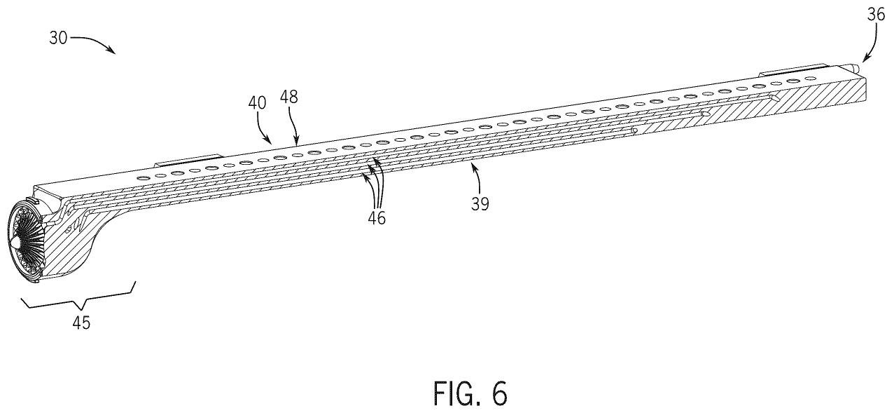

FIG. 6 is a cross-sectional view of the moistener column 36 of the moistener column assembly 30 of FIG. 4. The moistener column 36 includes fluid passages 46 that extend through the body 39 and are configured to flow cleaning solution from an inlet region 45 to the fluid outlets 40. In the illustrated embodiment, the body 39 also includes threaded holes 48 that enable the moistener pad holders to be coupled to the body 39. The fluid outlets 40, which are formed through additive manufacturing, alternate with the threaded holes 48. As such, each of the moistener pad assemblies receives fluid from a respective fluid outlet 40 and is coupled to the body 39 via a threaded hole.

In certain embodiments, each fluid passage 46 is configured to receive cleaning solution from the inlet region 45. As such, the inlet region 45 is formed to provide the cleaning solution to the fluid passages 46 (e.g., a substantially equal flow to each fluid passage). In some embodiments, the inlet region 45 is formed with the body 39 using additive manufacturing, thereby obviating coupling and/or linking of the inlet region to the fluid passages.

The moistener column 36, including the body 39, the fluid passages 46, the inlet region 45, and the fluid outlets 40, is formed using additive manufacturing. The fluid passages 46 facilitate flow of cleaning solution to the moistener pads. The fluid passages 46 formed by material of the body 39 extend through the body 39, creating respective fluid paths. The fluid paths enable the flow of cleaning solution from a first end (e.g., top, location of fluid inlet region) to a second end (e.g., bottom) of the body 39 (e.g., under the influence of gravity).

Because the fluid passages extend through the body and are formed by additive manufacturing, the moistener column assembly disclosed herein is free of individual hose nuts that may be employed to couple cleaning solution hoses to an inlet region/assembly, which are labor intensive to install. Accordingly, the assembly process may be substantially reduced (e.g., as compared to a moistener column assembly that includes cleaning solution hoses). Furthermore, because each fluid passage formed by material of the body 39 extends through the body build-up of other agricultural material on the fluid passages is obviated (e.g., as compared to a moistener column assembly that includes cleaning solution hoses).

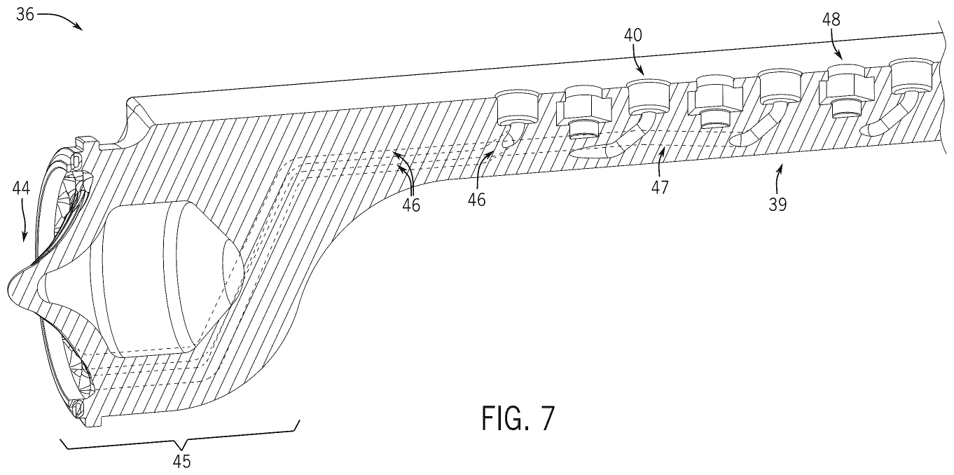

FIG. 7 is a cross-sectional view of a portion of the moistener column 36 of FIG. 6. In the illustrated embodiment, the moistener column 36 includes the inlet region 45, which is configured to receive cleaning solution and to provide the cleaning solution to the fluid passages 46 that extend through the body 39. Further, the fluid outlets 40 and the threaded holes 48 are disposed along the body 39. A fluid path 47, illustrated in FIG. 7 partially by dashed lines, facilitates flow of the cleaning solution from the inlet region 45 through the respective fluid passage 46 to a respective fluid outlet 40.

In certain embodiments, the fluid path 47 is not confined to one plane (e.g., horizontal or vertical). Accordingly, the respective fluid passage 46 is formed via additive manufacturing in a suitable configuration to enable flow of cleaning solution from the inlet region 45 to the respective fluid outlet 40. In other embodiments, the fluid path 47 may extend in other suitable direction(s). The fluid path 47 may extend longitudinally through the body 39 and then turn to intersect a respective fluid outlet 40. The angle of each turn of the fluid path 47 may be selected to facilitate flow of the cleaning solution through the respective fluid passage 46. For example, the radius of curvature of each turn may be determined based on the expected fluid pressure/flow rate to the respective fluid outlet.

Each fluid passage 46 may have a respective fluid path 47. Because the fluid passages 46 are formed by material of the body 39 using additive manufacturing, each fluid passage 46 may not be restricted to a particular fluid path 47, as compared to a fluid path established by a hose that may be restricted to particular configurations based on hose parameters (e.g., flexibility, rigidity). In certain embodiments, the fluid passages 46 formed by material of the body 39 may be formed with a cross-sectional area that varies along the respective fluid path 47 based on facilitating flow of the cleaning solution. For example, the fluid passages 46 may have greater cross-sectional area at turns of the fluid path 47 compared to straight portions of the fluid path 47 to facilitate flow of the cleaning solution. Furthermore, in some embodiments, the fluid passages 46 may be formed by material of the body 39 into particular a cross-sectional shape (e.g., circular, rectangular, triangular, etc.) to facilitate flow of the cleaning solution. Furthermore, in certain embodiments, the cross-sectional shape may be selected to maximize utilization of internal area of the body 39.

Because the fluid passages 46 are formed by material of the body 39 the fluid passages 46 have fixed configurations (e.g., as compared to a moistener column assembly having flexible cleaning fluid hoses). For example, the fluid passages 46 may obviate pinching of the fluid passages 46, substantially reducing assembly time (e.g., as compared to a moistener column assembly having flexible cleaning fluid hoses). Furthermore, because the fluid passages 46 are internal to the body 39 of the moistener column 36, cleaning of the moistener column assembly 30 during and/or after harvesting operations may be easier, as compared to a moistener column assembly having cleaning fluid hoses. For example, the moistener column assembly 30 may be significantly easier to clean with compressed air because the compressed air may readily engage each surface of the moistener column assembly (e.g., as compared to a moistener column assembly having hoses with a large number of surfaces).

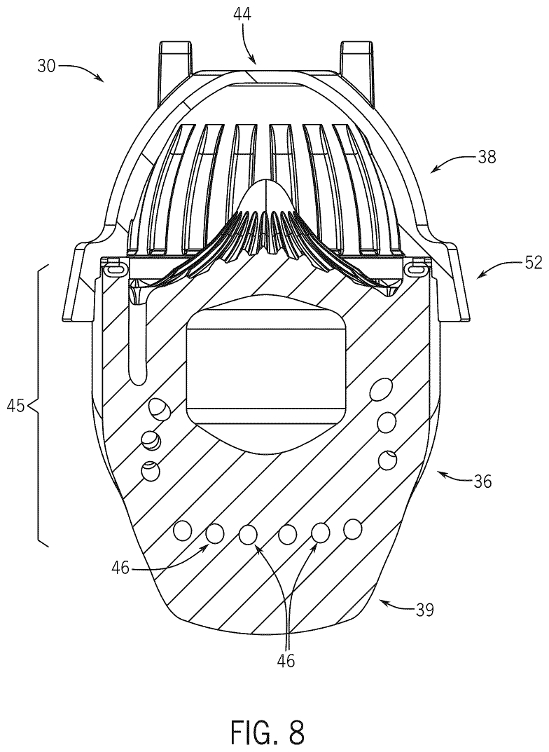

FIG. 8 is a cross-sectional view of a portion of the moistener column assembly 30 of FIG. 4. As illustrated, the inlet region 45 of the moistener column 36 is fitted with the cap 38 via the quarter-turn snap connector 52. The inlet region 45 is directly fluidly coupled with the fluid passages 46. As such, the cleaning solution is able to move continuously from the first end of the body to the fluid outlets. As previously discussed, the fluid passages 46 are configured to extend through the body 39. The fluid passages 46 formed by material of the body 39 are distributed around a central divider that directs the cleaning solution into each fluid passage 46, however; it should be noted that any suitable configuration of the fluid passages 46 may be formed via additive manufacturing.

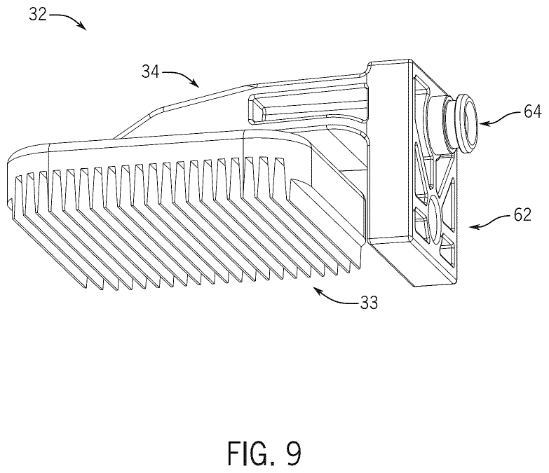

FIG. 9 is a perspective view of a moistener pad assembly 32 of the moistener column assembly of FIG. 4. The moistener pad assembly 32 includes the moistener pad 33 and the moistener pad holder 34. The moistener pad holder 34 includes a hole 62 and a fluid coupler 64. The hole 62 is configured to receive a fastener that engages a respective threaded hole in the body of the moistener column, thereby coupling the moistener pad assembly 32 to the body of the moistener column. In addition, the fluid coupler 64 is configured to engage a respective fluid outlet of the moistener column. Fluid passage(s) extend through the moistener pad holder to facilitate fluid flow from the fluid outlet, through the fluid coupler 64, through the moistener pad holder fluid passage(s), and through openings in the moistener pad 33. The moistener pad assembly 32 is coupled to the body of the moistener column as illustrated previously in FIG. 4. In certain embodiments, the moistener pad assembly 32 is formed via additive manufacturing. In other embodiments, the moistener pad assembly is formed via machining, casting, welding, etc. In the illustrated embodiment, the moistener pad 33 and the moistener pad holder 34 are formed as two parts. In some embodiments, the moistener pad and the moistener pad holder are formed as one part to reduce the number of parts.

In some embodiments, the moistener pad holder includes a fluid coupler configured to couple with a respective fluid outlet disposed on the body of the moistener column. As such, the moistener pad assembly may be coupled to the body using the fluid coupler, which may include a suitable device (e.g., snap-fit joint, twist joint, tongue and groove joint, dovetail joint, peg joint) to couple the moistener pad assembly to the body and to seal the moistener pad assembly fluid passage(s) to the respective fluid outlet. In such embodiments, the opening in the moistener pad holder may be omitted. Furthermore, in certain embodiments, the moistener pad holder may include any other suitable connector(s) configured to couple the moistener pad holder to the body of the moistener column.

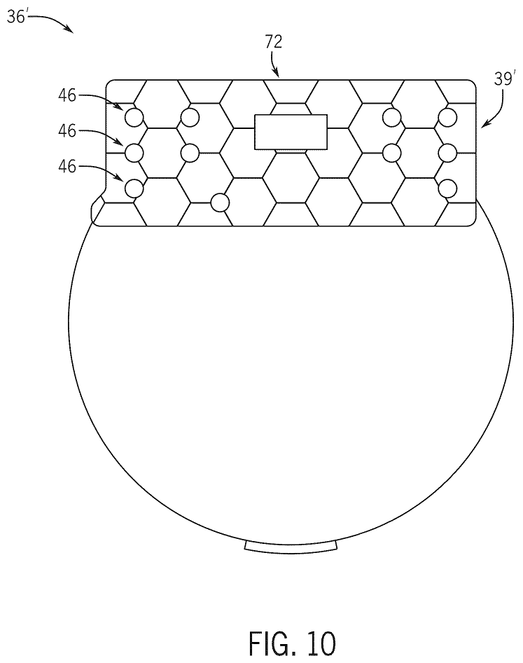

FIG. 10 is a cross-sectional view of an embodiment of a moistener column 36′ that may be employed within the moistener column assembly of FIG. 4. As previously discussed, the fluid passages 46 may extend through the body 39′ of the moistener column 36′. In the illustrated embodiment, the internal structure of the body 39′ includes a honey comb structure 72. The honey comb structure 72 reduces the weight of the moistener column assembly and/or the time sufficient to form the moistener column 36′ using additive manufacturing. In certain embodiments, the honey comb structure 72 may significantly reduce the mass of the moistener column assembly when compared to alternative moistener column configurations. While the body includes the honey comb structure in the illustrated embodiment, in other embodiments, the body may include another suitable structure that provides voids to reduce the weight and/or additive manufacturing time of the moistener column. Furthermore, with the exception of the body including the honey comb structure/voids, the remainder of the features, variations, and assembly methods disclosed above with reference to FIGS. 1-9 apply to the moistener column 36′ of FIG. 10.

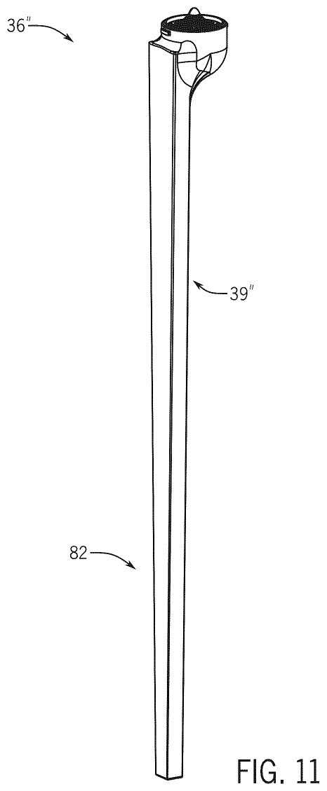

FIG. 11 is a perspective view of another embodiment of a moistener column 36″ that may be employed within the moistener column assembly of FIG. 4. As illustrated, the body 39″ of the moistener column 36″ is formed with a tapered end 82. The tapered end 82 may reduce the weight of the moistener column assembly and/or the time sufficient to form the moistener column through additive manufacturing. Furthermore, the tapered end 82 may reduce space needed in the row unit for installation of the moistener column assembly. Because the fluid passages extending through the body decrease in number as the fluid passages meet the fluid outlets, the tapered end may not interfere with the fluid passages, but may reduce material sufficient for fabrication. In certain embodiments, the moistener column 36″ formed with the tapered end 82 may include the internal structure that includes the honey comb structure. Furthermore, with the exception of the shape of the body, the remainder of the features, variations, and assembly methods disclosed above with reference to FIGS. 1-9 apply to the moistener column 36″ of FIG. 11.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method for manufacturing a moistener column assembly for a row unit of an agricultural header, comprising:
forming a moistener column of the moistener column assembly via an additive manufacturing process, comprising:
forming an inlet region via the additive manufacturing process, wherein the inlet region is configured to receive fluid while installed on the row unit;
forming a body extending from the inlet region via the additive manufacturing process, wherein the inlet region is disposed on a first end of the body; and
forming a plurality of fluid passages extending through the body via the additive manufacturing process, wherein the plurality of fluid passages extend to the inlet region; and
forming a plurality of fluid outlets via the additive manufacturing process, wherein each of the plurality of fluid passages is configured to receive the fluid from the inlet region and to expel the fluid through a respective fluid outlet of the plurality of fluid outlets, and the plurality of fluid outlets are distributed along a longitudinal axis of the moistener column assembly.

2. The method of claim 1, comprising:
forming a plurality of moistener pad holders via another additive manufacturing process, wherein each moistener pad holder of the plurality of moistener pad holders is configured to support a respective moistener pad; and
coupling the plurality of moistener pad holders to the body of the moistener column.

3. The method of claim 2, comprising forming a plurality of threaded holes within the body via the additive manufacturing process, wherein each threaded hole of the plurality of threaded holes is configured to receive a respective fastener, and coupling the plurality of moistener pad holders to the body comprises engaging each respective fastener with a corresponding threaded hole of the plurality of threaded holes.

4. The method of claim 2, comprising forming a plurality of fluid couplers via the additive manufacturing process, wherein the plurality of fluid couplers is configured to receive the fluid from at least one fluid outlet of the plurality of fluid outlets, and coupling the plurality of moistener pad holders to the body comprises engaging at least one of fluid outlet of the plurality of fluid outlets with a corresponding fluid coupler of the plurality of fluid couplers.

5. The method of claim 1, comprising selecting a number of the plurality of fluid outlets based on a number of moistener pads of the moistener column assembly.

6. The method of claim 1, wherein the moistener column assembly is formed as one piece.

7. The method of claim 1, wherein the moistener column assembly comprises:
forming a cap via another additive manufacturing process, wherein the cap includes a quarter-turn snap connector, and the body includes a corresponding connector;
disposing an o-ring between the body and the cap; and
coupling the cap to the body via the quarter-turn snap connector.

8. The method of claim 1, wherein the body tapers at a second end, opposite the first end.

9. The method of claim 1, wherein the body comprises a honey comb structure.

10. The method of claim 1, wherein the moistener column assembly comprises:
selecting a cross-sectional shape of at least one fluid passage of the plurality of fluid passages based on facilitating flow of the fluid; and
selecting a cross-sectional area of at least one fluid passage of the plurality of fluid passages based on facilitating flow of the fluid.

11. A moistener column assembly for a row unit of an agricultural header, comprising:
a moistener column, comprising:
an inlet region configured to receive fluid while installed on the row unit;
a body extending from the inlet region, wherein the inlet region is disposed on a first end of the body;
a plurality of fluid passages extending through the body, wherein the plurality of fluid passages extend to the inlet region, and each fluid passage of the plurality of fluid passages is formed by material of the body; and
a plurality of fluid outlets;
wherein each of the plurality of fluid passages is configured to receive the fluid from the inlet region and to expel the fluid through a respective fluid outlet of the plurality of fluid outlets, and the plurality of fluid outlets are distributed along a longitudinal axis of the body.

12. The moistener column assembly of claim 11, wherein the body tapers at a second end, opposite the first end.

13. The moistener column assembly of claim 11, wherein the moistener column assembly is formed as one piece.

14. The moistener column assembly of claim 11, wherein the body of the moistener column comprises a honey comb structure.

15. The moistener column assembly of claim 11, wherein at least one of the plurality of fluid passages has a circular cross-sectional shape.

16. The moistener column assembly of claim 11, comprising a plurality of moistener pad holders coupled to the body, wherein each moistener pad holder of the plurality of moistener pad holders is configured to receive the fluid from a respective fluid outlet of the plurality of fluid outlets.

17. The moistener column assembly of claim 16, wherein the body of the moistener column has a plurality of threaded holes configured to receive a respective plurality of fasteners to couple the plurality of moistener pad holders to the body.

18. A moistener column assembly for a row unit of an agricultural header formed by a method, comprising:
forming a moistener column of the moistener column assembly via an additive manufacturing process, comprising:
forming an inlet region via the additive manufacturing process, wherein the inlet region is configured to receive fluid while installed on the row unit;
forming a body extending from the inlet region via the additive manufacturing process, wherein the inlet region is disposed on a first end of the body; and
forming a plurality of fluid passages extending through the body via the additive manufacturing process, wherein the plurality of fluid passages extend to the inlet region, and each fluid passage of the plurality of fluid passages is formed by material of the body; and
forming a plurality of fluid outlets via the additive manufacturing process, wherein each of the plurality of fluid passages is configured to receive the fluid from the inlet region and to expel the fluid through a respective fluid outlet of the plurality of fluid outlets, and the plurality of fluid outlets are distributed along a longitudinal axis of the moistener column assembly.

19. The moistener column assembly of claim 18, wherein the method comprises:
forming a plurality of moistener pad holders via another additive manufacturing process, wherein each moistener pad holder of the plurality of moistener pad holders is configured to support a respective moistener pad; and
coupling the plurality of moistener pad holders to the body of the moistener column.

20. The moistener column assembly of claim 18, wherein the method comprises:
forming a cap via another additive manufacturing process, wherein the cap includes a quarter-turn snap connector, and the body includes a corresponding connector;
disposing an o-ring between the body and the cap; and
coupling the cap to the body via the quarter-turn snap connector.
